(19) United States
(12) Patent Application Publication
(10) Pub. No.: US 2007/0020579 A1
(43) Pub. Date: Jan. 25, 2007

(54) Tooth powdering device

(76) Inventor: Michael Migdal, Paramus, NJ (US)

Correspondence Address: Abraham P. Ronai, Esq.;Kenyon & Kenyon, One Broadway, New York, NY, 10004, US

(21) Appl. No.: 11/189,675

(22) Filed: Jul. 25, 2005

(51) Int. Cl. A61C 3/02

(52) U.S. Cl. 433/88

(57) ABSTRACT

A tooth powdering system for application of a reflective powder to the surface of a tooth. The tooth powdering system includes a base and powder container removably stored in the base. The powder container is connected to a hand-held applicator and a source of pressurized gas, which is controlled by a foot pedal.

### FIELD OF THE INVENTION

The present invention relates to a tooth powder applicator. More particularly, the invention relates to a tooth powdering system for application of a reflective powder to the surface of a tooth.

### BACKGROUND INFORMATION

Tooth powdering devices are known in the art for creating tooth replicas and for facilitating photographs of the teeth. U.S. Pat. Nos. 5,944,521 and 6,099,306, assigned to Powder Meister, Inc., and U.S. Pat. No. 6,416,322, assigned to Ourglass, Ltd (“the PowderPerfekt device”), disclose hand-held tooth powdering applicators. Both applicators are designed so as to allow a dentist to hold a container storing the powder in one hand and direct the powder by rotating a rigid applicator extending from the powder container with the other hand. The hand directing the applicator may also be used to control the air pressure entering the powder container via a push button control valve on the powder container, in the case of the Powder Meister device, or on a dry air syringe connected to the powder container, in the case of the Powder Perfekt device.

Drawbacks to the prior art tooth powdering devices are numerous. First, movement of the hand-held powder container may cause the flow of powder to vary during application. This is problematic because an uneven application of the powder results in an inaccurate tooth replica. Second, holding the powder container while pressing the push button valve on or near the powder container makes for an unwieldy use and a sharp learning curve. Third, continuous exposure of the powder in the powder container to high pressure gas may result in clogging of the powder.

Therefore, while the prior art tooth powder applicators may be suitable for the particular purpose employed, or for general use, they are not as suitable for the purposes of the present invention as disclosed hereafter. Accordingly, it is an object of the present invention to provide a tooth powder applicator which overcomes the disadvantages of the prior art.

### SUMMARY

An example embodiment of the tooth powdering system of the present invention includes a container configured to hold a powder, a base configured to hold the container; and an applicator configured to dispense the powder. The container is configured to connect to a pressurized gas supply via a first conduit, such as a flexible hose or tube, and communicates with the applicator. The tooth powdering system is configured such that the container is only pressurized via the gas supply during application of the powder through the applicator.

In an exemplary embodiment of the present invention, the powder may be reflective and configured to adhere to the surface of a tooth.

In an exemplary embodiment of the present invention, the base may include a recess configured to removably receive the container and/or an elongated recess in the shape of the applicator.

In an exemplary embodiment of the present invention, adjacent a top of the container the container may include an inlet for connection to the gas supply and an outlet for connection to the applicator. The container may also include a cap over an opening at a top of the container, wherein the container inlet and outlet are in the cap.

In an exemplary embodiment of the present invention, the pressurized gas supply may supply pressurized air.

In an exemplary embodiment of the present invention, the powdering system may include a pressurized gas supply, which may be connected to the container via flexible tubing.

In an exemplary embodiment of the present invention, the powdering system may include a foot pedal configured to control the flow of gas from the gas supply to the container, wherein depression of the foot pedal allows the gas supply and the container to communicate such that high pressure from the gas supply forces at least some of the powder out through the applicator.

In an exemplary embodiment of the present invention, the powdering system may include a regulating valve downstream of the gas supply and upstream of the container configured to limit the maximum gas pressure entering the container. The regulating valve may be removably connected to the base.

In an exemplary embodiment of the present invention, the gas supply may be connected to an input of the regulating valve via a first flexible tube and an output of the regulating valve may be connected to the container via a second flexible tube.

In an exemplary embodiment of the present invention, the regulating valve may be connected to one side of the base and extend into a recess in the base, the first flexible tube extending into the recess where it connects to the regulating valve.

In an exemplary embodiment of the present invention, the container may communicate with the applicator via a second conduit, such as a flexible hose or tube.

An exemplary embodiment of the tooth powdering system of the present invention may include an applicator configured to dispense a powder, a base, a pressurized gas supply, a valve configured to control the flow of gas from the gas supply into the container, and a container configured to hold the powder. The container may be (i) contained in the base, (ii) connected at an input to the gas supply and (iii) connected at an output to the applicator.

In an exemplary embodiment of the present invention, the container may be removably contained in the base.

In an exemplary embodiment of the present invention, the applicator may be connected to the output of the container via a flexible hose.

An exemplary embodiment of a tooth powdering system of the present invention may include a container means for containing a powder, a means for holding the container means, and an applicator means for dispensing the powder. The container means may be configured to connect to a pressurized gas supply means and may communicate with the applicator means. The tooth powdering system may be configured such that the container means is only pressurized via the gas supply means during application of the powder through the applicator means.

An exemplary method for using the tooth powdering system of the present invention includes holding a tip of the applicator adjacent a tooth to be powdered, the base remaining stationary, and opening the valve so as to allow the pressurized gas to flow into the container forcing the gas and the powder out of the applicator onto the tooth. The valve may be controlled by a foot pedal and opening of the valve may be effected by depressing the foot pedal.

Example embodiments of the present invention may be embodied in the form illustrated in the accompanying drawings. Attention is called to the fact, however, that the drawings are illustrative only. Variations are contemplated as being part of the present invention, limited only by the scope of the appended claims.

### BRIEF DESCRIPTION OF THE DRAWINGS

In the drawings, like elements are depicted by like reference numerals. The drawings are briefly described as follows.

FIG. 1 is a perspective view of an exemplary embodiment of the tooth powdering system of the present invention.

FIG. 2 is a perspective view of the tooth powdering system of FIG. 1 with the applicator and powder container displaced above their respective holding recesses.

FIG. 3 is a cross sectional view of the powder container.

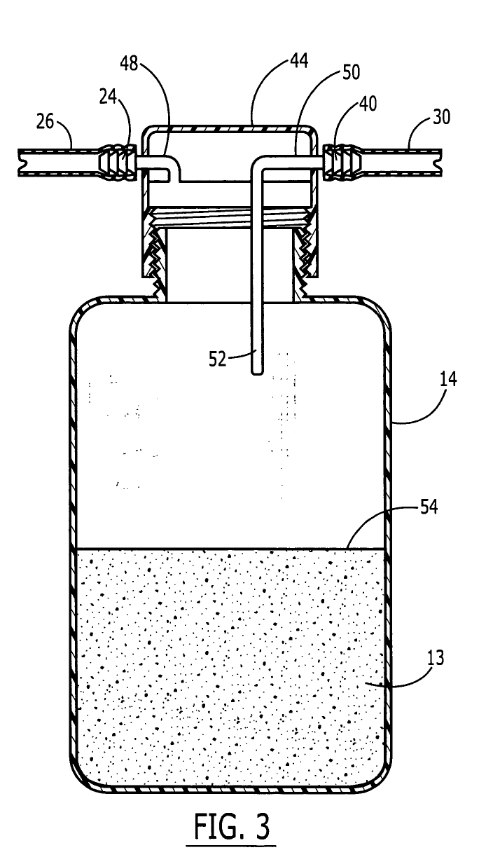

FIG. 4 is a bottom view of the base with the remaining components of the device arranged to the side of the base.

### DETAILED DESCRIPTION

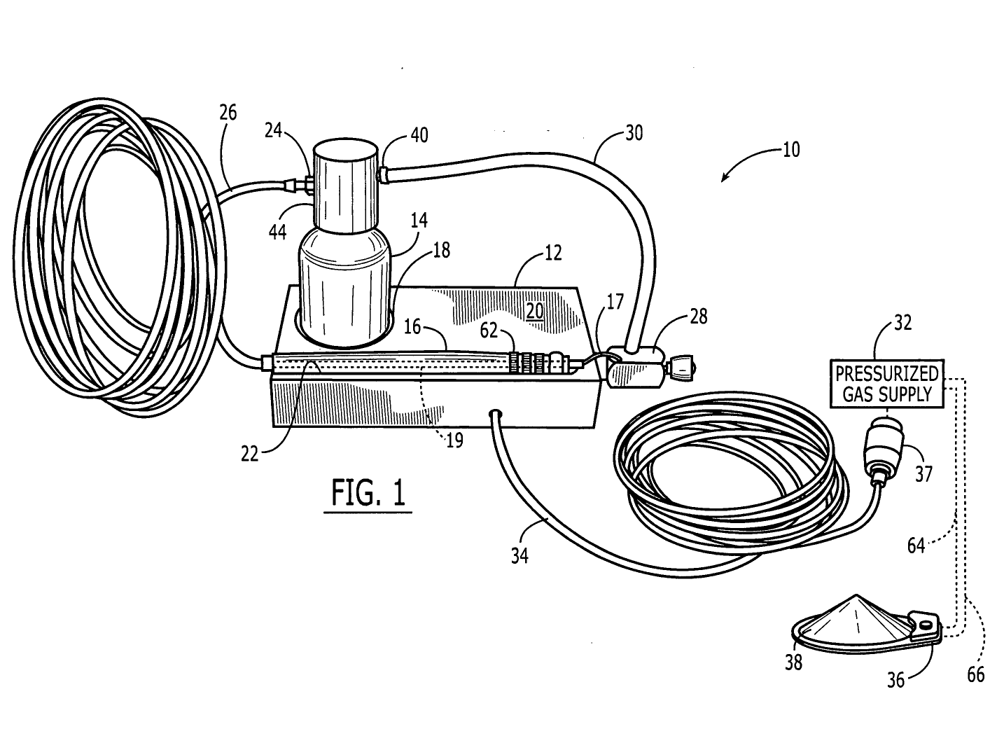

FIG. 1 illustrates a perspective view of an exemplary embodiment of the powdering system 10 of the present invention. The powdering system 10 includes a base 12, a powder container 14 and a hand-held applicator 16. Hand-held applicator 16 may include ribs 62 to enhance grip and a tip portion 17, for example, a curved tip portion, to facilitate delivery of a powder jet ejected from the applicator 16. In an exemplary embodiment of the invention the powder container 14 may be integral with base 12.

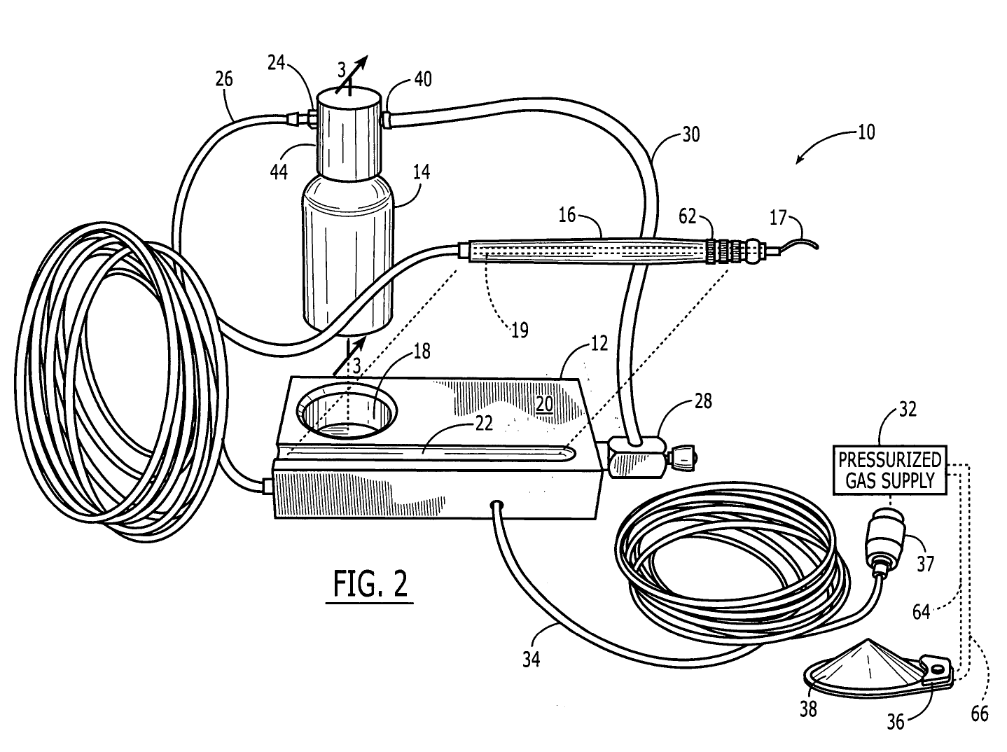

FIG. 2 illustrates a perspective view of the powdering system with the powder container 14 and the applicator 16 displaced so as to provide an unobstructed view of an entire top surface 20 of the base. The powder container 14 may be removably contained in a recess 18 in the top surface 20 of the base 12. The hand-held applicator 16 may rest in an elongated recess 22 in the top surface 20 of the base 12 when not in use.

The powder container 14 may contain a powder 13, for example, a reflective powder made from titanium oxide and talc powder. Powder 13 may be forced under high pressure, for example, pressures between 0 and 40 psi, through a lumen 19 (shown in ghost lines) extending the length of the applicator 16. The powder container 14 may be connected to the applicator 16 at an outlet, for example, barbed outlet 24 via a first conduit 26, such as a flexible tube. The conduit 26 may be of sufficient length so as to allow a dentist or other user to position the applicator adjacent an object to be coated, for example, a tooth, without moving the base 12, which may be placed, for example, on a table or stand adjacent the patient's seat. Movement of the base 12 and the powder container 14 on the base 12 may result in an uneven flow of powder through the applicator 16 and, thus, in an uneven application of powder 13 on the object being coated. So as to prevent slippage, base 12 may be made from a dense heavy material, such as metal, or may be made from a plastic and weighed down with a heavy material. Base 12 may also contain legs or pads 15 on a bottom surface 58, which may also prevent slippage. Legs or pads 15 may be made, for example, from rubber.

The powder container 14 may be connected to a regulating valve 28 via a second conduit 30, which in turn may be connected to a pressurized gas supply 32 via a third conduit 34, such as flexible tube. Third conduit 34 is of sufficient length so as to span the distance between the gas supply 32 and the base 12.

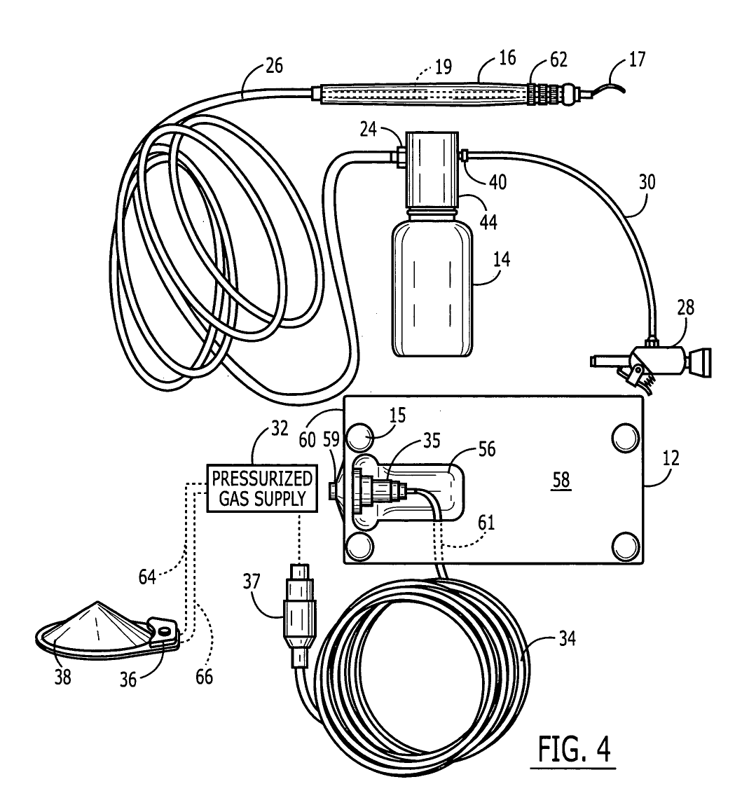

The regulating valve 28 may be set by a user to limit the maximum pressure at which gas is received from the gas supply 32. Alternatively, the powder container 14 may be connected directly to the pressurized gas supply 32. Regulating valve 28 may be connected to third conduit 34 via a connector 35, which may be connected to the base 12. As can be seen in the bottom view of the base shown in FIG. 4, connector 35 may at least partially lie in a recess 56 in the bottom surface 58 of the base 12 and may project from a side 60 of the base 12 so as to expose a tip portion 59 for removable connection to the regulating valve 28. Third conduit 34 may pass through a passage 61 (shown in ghost lines) in the base 12 into recess 56 where it may connect to connector 35. On an opposite end, third conduit 34 may include another connector 37 configured to connect to gas supply 32. Regulating valve 28 is shown in FIG. 4 disconnected from the base 12. Further, container 14 and applicator 16 are shown to the side of the base 12.

The gas supply 32 may be a standard air compressor used in a dentist's office. In an exemplary embodiment of the present invention, the same gas supply used to power standard dental hand pieces, such as an air turbine drill, may be used to provide pressurized gas to the powder container 14. A valve 36, for example, controlled by a standard foot pedal 38, upstream of the powder container 14 may be utilized to control the pressure delivered by the gas supply 32 to the powder container 14. Valve 36 may comprise a standard type mechanical valve or any other means known in the art for controlling the flow of a gas. Valve 36 may communicate with the gas supply 32 via an input line 64 and output line 66. Use of the foot pedal 38 to control powder flow allows a user to focus on positioning the applicator 16. This is in contrast to prior art devices, such as the Powder Meister and PowderPerfekt devices, which require a user to use his or her hands to both hold and direct the powder container and applicator and also to depress a valve button to trigger flow of powder.

Positioning of the valve 36 and/or foot pedal 38 upstream of the powder container prevents application of pressurized gas to the powder 13 during periods of nonuse of the device. In other words, unless the foot pedal 38, for example, is depressed the powder container 14 is not pressurized. This selective application of pressure to the powder 13 may reduce clogging of the powdering system 10.

First conduit 26 may be connected to an outlet, for example barbed outlet 24, of the powder container 14 and second conduit 30 may be connected to an inlet, for example, barbed inlet 40 of the powder container 14. In an exemplary embodiment of the invention, the inlet 40 and outlet 24 may project from a cap 44 of the powder container 14. Alternatively, inlet 40 and outlet 24 may project from a body portion of powder container 14. As can be seen in the cross section of powder container 14 taken along lines 3-3 in FIG. 2, outlet 24 may communicate with an interior of the powder container 14 via a first passage 48 in cap 44. Inlet 40 may communicate with a second passage 50 in cap 44 and a tube 52, which extends downward into the powder container 14 but remains above powder line 54. In other words, tube 52 does not extend into the powder 13 while the powder container 14 is maintained level, steady and not pressurized. Cap 44 may be removably connected to powder container 14, for example, via a threaded connection or a snap fit.

In an exemplary embodiment of the powdering system 10, as an alternative or in combination with valve 36 and/or foot pedal 38, a valve may be placed directly on cap 44 or on second conduit 30 so as to control the entry of pressurized gas from gas supply 32 through second passage 50 using finger control as opposed to foot control via foot pedal 38.

In an exemplary embodiment of the powdering system 10, the powder container 14 may be removed from the based and connected directly to the gas supply 32. In use the dentist would hold the container in one hand and the applicator 16 with the other hand. Further, the applicator 16 may be directly connected to the powder container allowing the dentist to hold the entire device in one hand. In which case, the applicator may be rotatably connected to the powder container 14 allowing it to rotate.

In an exemplary embodiment of the present invention, the powdering system 10 may include a barrier, such as a plate with holes, inside the powder container 14 over the powder line 54, which may be useful in preventing large clumps of powder from clogging the system.

In an exemplary embodiment of the present invention, the powdering system 10 may also include a filter along second conduit 30 or in powder container 14. The filter may be water absorbent.

As many apparently widely different embodiments of the present invention may be made without departing from the spirit and scope thereof, it is to be understood that the present invention is not limited to the specific embodiments thereof except as defined in the appended claims.

1. A tooth powdering system, comprising:
a container configured to hold a powder;
an applicator configured to dispense the powder, wherein the container is configured to connect to a pressurized gas supply and communicates with the applicators; and
a foot pedal used to control a gas pressure delivered to the container so as to force the gas and powder out of the container and through the applicator,
wherein the tooth powdering system is configured such that the gas pressure delivered to the container is controlled and selected from a predetermined gas pressure range by depressing the foot pedal;
wherein the tooth powdering system is configured such that the container is only pressurized via the gas supply during application of the powder through the applicator.

2. The tooth powdering system of claim 1,
wherein the powder is reflective.

3. The tooth powdering system of claim 1,
wherein the powder is configured to adhere to the surface of a tooth.

4. The tooth powdering system of claim 10,
wherein the base includes a recess configured to removably receive the container.

5. The tooth powdering system of claim 10,
wherein the base includes an elongated recess in the shape of the applicator.

6. The tooth powdering system of claim 1,
wherein adjacent a top of the container the container includes an inlet for connection to the gas supply and an outlet for connection to the applicator.

7. The tooth powdering system of claim 6,
wherein the container includes a cap over an opening at a top of the container, and the container inlet and outlet are in the cap.

8. The tooth powdering system of claim 1,
wherein the pressurized gas supply supplies pressurized air.

9. The tooth powdering system of claim 1, further comprising:
the pressurized gas supply.

10. The tooth powdering system of claim 9, further comprising:
a base configured to hold the container.

11. (canceled)

12. The tooth powdering system of claim 9, further comprising:
a regulating valve downstream of the gas supply and upstream of the container configured to limit the maximum gas pressure entering the container.

13. (canceled)

14. The tooth powdering system of claim 12, further comprising:
a base configured to hold the container,
wherein the regulating valve is removably connected to the base.

15. The tooth powdering system of claim 14,
wherein the gas supply is connected to an input of the regulating valve via a first flexible tube and an output of the regulating valve is connected to the container via a second flexible tube.

16. The tooth powdering system of claim 15,
wherein the regulating valve is connected to one side of the base and extends into a recess in the base, the first flexible tube extending into the recess where it connects to the regulating valve.

17. The tooth powdering system of claim 1,
wherein the container communicates with the applicator via a second conduit.

18. The tooth powdering system of claim 17,
wherein the first conduit is a flexible hose and the second conduit is a flexible hose.

19-22. (canceled)

23. A tooth powdering system, comprising:
a container means for containing a powder;
a means for holding the container means;
an applicator means for dispensing the powder, wherein the container means is configured to connect to a pressurized gas supply means and communicates with the applicator means; and
a foot control means for controlling a gas pressure delivered from the gas supply to the container,
wherein the tooth powdering system is configured such that the gas pressure delivered to the container means is controlled and selected from a predetermined gas pressure range by depressing the foot control means;
wherein the tooth powdering system is configured such that the container means is only pressurized via the gas supply means during application of the powder through the applicator means.

24. A method for powdering a tooth comprising the steps of:
a) holding a tip of a powder applicator adjacent a tooth to be powdered, a container, holding the powder and in communication with the applicator, remaining stationary;
b) using a foot pedal to control and select a gas pressure from a predetermined gas pressure range for delivery to the container;
c) forcing the gas and the powder out of the applicator onto the tooth; and
d) maintaining the container in an unpressurized state when powder is not flowing through the applicator.

24. The method of claim 23, further comprising the step of:
adjusting a valve connected between a pressure source for the gas and the container so as to limit a maximum gas pressure delivered to the container.
